(19) United States
(12) Patent Application Publication
(10) Pub. No.: US 2009/0189360 A1
(43) Pub. Date: Jul. 30, 2009

(54) Spring Strut with Adjustable Spring Plate

(75) Inventor: Michael Fritz, Breckerfeld (DE)

Correspondence Address: CROWELL & MORING LLP;INTELLECTUAL PROPERTY GROUP, P.O. BOX 14300, WASHINGTON, DC, 20044-4300, US

(73) Assignee: Thyssenkrupp Bilstein Suspension GmbH, Ennepetal (DE)

(21) Appl. No.: 12/337,283

(22) Filed: Dec. 17, 2008

(30) Foreign Application Priority Data
Jan. 25, 2008 (DE) 102008006087.9

(51) Int. Cl. B60G 17/02

(52) U.S. Cl. 280/5.519

(57) ABSTRACT

The invention relates to a spring strut for wheel suspension systems of vehicles, having a vibration damper (1) and a helical spring (2) partially surrounding the vibration damper (1), wherein the helical spring (2) is supported via a spring plate (3) on an outer pipe (4) of the vibration damper (1) and the spring plate (3) can be adjusted relative to the outer pipe (4). In order to develop such a spring strut in such a way that the standing height of vehicles with different unladen weights can be adjusted to always be the same by adjusting the spring plate, without the friction between the piston rod and the sealing and guiding assembly being disadvantageously increased, it is proposed in accordance with the invention that the line of application of force (5) of the helical spring (2) forms an acute angle (α) with the longitudinal axis (6) of the vibration damper (1) and the position of the spring plate (3) can be adjusted in the direction of the line of application of force (5).

The invention relates to a spring strut with the features of the preamble of claim 1.

A generic spring strut is known from DE 26 56 707 A1. In the introduction to the description of DE 26 56 707 A1 the problem is presented that, owing to the rich selection of optional extras for motor vehicles, the unladen weight of a particular vehicle type varies widely depending on the options selected. If no suitable countermeasures are taken this variation in the unladen weight leads to vehicles having different standing heights since the vehicle spring of the spring strut is compressed to different degrees under the different unladen weights. Standing height of the vehicle is to be understood to mean the distance of the vehicle body from the ground on which the vehicle is standing when in the inoperative state.

One countermeasure known from practical experience which can be used to ensure that the standing height of the vehicle body with respect to the road surface is always the same even with different unladen weights for a particular vehicle type consists of using helical springs which differ with respect to their length and/or their other characteristics (e.g. spring stiffness). By using different helical springs it is possible always to ensure the same standing height in spite of different vehicle weights. However, this requires that a large stock of different vehicle springs has to be maintained. Furthermore, there is a risk of using the wrong spring so that the wrong standing height is set for a given vehicle with a given unladen weight if the incorrect vehicle spring is installed.

In order to avoid the above-mentioned disadvantages it is proposed in accordance with DE 26 56 707 A1 that the spring plate be attached in a releasable manner to the outer shock absorber pipe and in such a way as to be displaceable axially in parallel with the longitudinal axis of the outer pipe. In this way the length of the vehicle spring can be changed by displacing the spring plate and can be adapted to the unladen weight of the vehicle. By axially displacing the spring plate in the direction of the longitudinal axis of the outer pipe the spring length is therefore adapted in such a way that vehicles of one vehicle type with different unladen weights always have the same standing height.

The means of solving this problem known from DE 26 56 707 A1 have the disadvantage that when the line of application of force of the helical spring deviates from the longitudinal axis of the shock absorber pipe and forms an acute angle with this longitudinal axis, the axial displacement of the spring plate leads to the transverse force which is transmitted from the helical spring to the piston rod of the vibration damper being changed in an uncontrolled manner because in spring struts the helical spring is often supported via a second spring plate attached to the piston rod of the vibration damper, by means of which spring plate a spring force acts upon the piston rod in the transverse direction. This transverse force acting on the piston rod can reach undesirably high values owing to the axial displacement of the spring plate in the direction of the longitudinal axis of the shock absorber pipe so that there is an unacceptably high level of friction between the piston rod and the sealing and guiding assembly which closes the shock absorber pipe and guides the piston rod.

The object of the invention is to develop a spring strut having the features of the preamble of claim 1 in such a way that the standing height of vehicles with different unladen weights can always be adjusted to be the same by adjusting the spring plate so that the friction between the piston rod and sealing and guiding assembly remains almost constant and does not exceed a component-specific value.

This object is achieved by a spring strut having the features of claim 1. Advantageous developments are given in the subordinate claims.

The present invention can be applied in a particularly advantageous manner in the case of so-called McPherson spring struts. In these spring struts the line of application of force of the vehicle support spring formed as a helical spring frequently deviates in the installed condition from the longitudinal axis of the vibration damper and forms an acute angle with this longitudinal axis. The invention is based on the knowledge that if the spring plate is displaced in the direction of the line of application of force of the helical spring there is then no undesired change in the transverse force transmitted from the helical spring to the piston rod of the vibration damper and therefore no undesired increase in friction between the piston rod and sealing and guiding assembly. Although the displacement of the spring plate along the line of application of force of the helical spring means that the spring length is adjusted and therefore the standing height of the vehicle body is influenced in a controlled way, the transverse force transmitted from the helical spring to the piston rod of the vibration damper does not change and the friction between the piston rod and sealing and guiding assembly remains substantially constant. In this way the transverse force transmitted from the helical spring to the piston rod of the vibration damper is always the same in all variations of a vehicle type with different unladen weights so that the friction of the piston rod in the sealing and guiding assembly closing the shock absorber pipe is also always substantially the same.

According to a preferred embodiment of the invention a hollow cylindrical sleeve is disposed on the outer pipe of the vibration damper, on which sleeve the spring plate is supported. When the centre line of the sleeve forms an acute angle with the longitudinal axis of the outer pipe the outer surface of the sleeve can be used as a guide surface for displacement of the spring plate. In this way a controlled and guided displacement of the spring plate is easily ensured, wherein the direction of the displacement deviates from the longitudinal axis of the outer pipe.

In order to vary the relative position of the spring plate with respect to the sleeve it is advantageous if spacing discs are inserted between the spring plate and the sleeve. By means of the spacing discs the relative position of the spring plate to the sleeve can be adjusted as desired. In order that the spring plate can be supported against the sleeve via the spacing discs the sleeve advantageously has a support collar on which the spacing discs are supported.

The spacing discs and/or the spring plate can be positioned so as not to rotate with respect to the damper pipe. This is particularly necessary with McPherson spring struts.

According to a particularly advantageous embodiment of the invention the sleeve is disposed in an inclined manner with respect to the outer pipe so that the outer pipe partially penetrates the sleeve, which is disposed with its centre line inclined with respect to the longitudinal axis of the outer pipe, such that the sleeve has apertures which receive the outer pipe. These apertures can advantageously be defined by a penetration curve which is adapted to the surface of the outer pipe.

In order to connect the sleeve firmly to the outer pipe provision is made in accordance with one embodiment of the invention that the sleeve is connected at least in portions to the outer pipe along the edge of at least one of the apertures. The connection between the sleeve and outer pipe can advantageously be formed as an integrally bonded connection, in particular as a welded, soldered or adhesive connection. Alternatively the connection can also be formed as a plug connection or clamped connection.

The invention is explained in more detail hereinunder with the aid of an exemplified embodiment illustrated in the drawing in which:

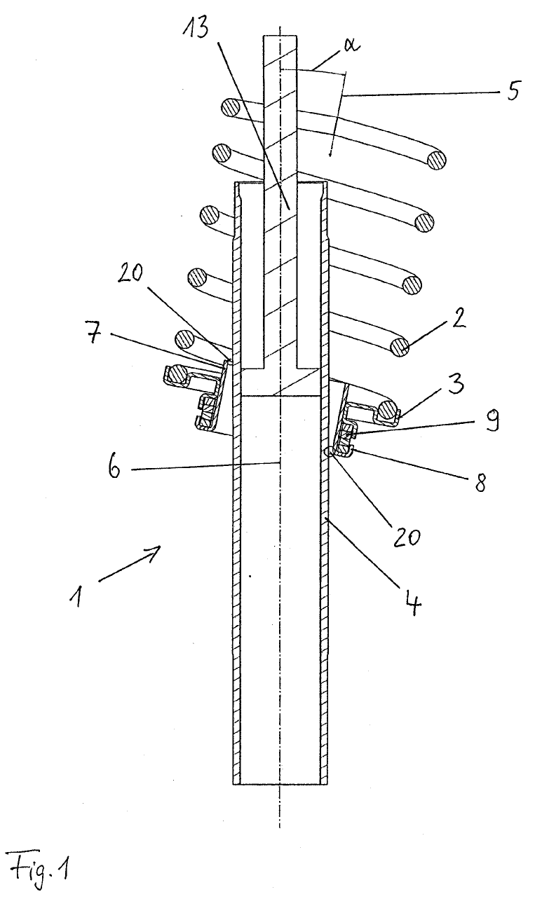

FIG. 1: illustrates a spring strut in accordance with the invention as an axial half cross-section showing a first option for adjusting the relative position of the spring plate with respect to the sleeve;

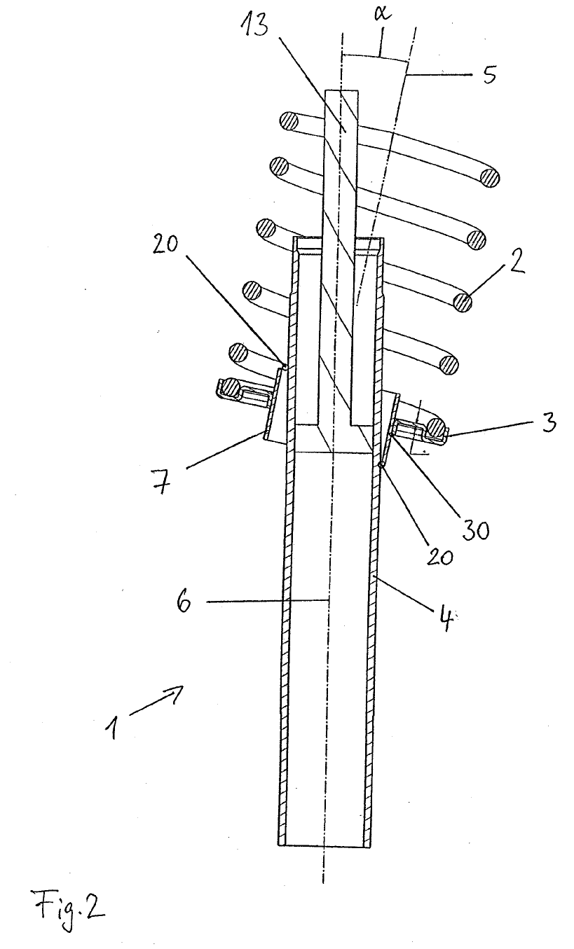

FIG. 2: illustrates a spring strut in accordance with FIG. 1 showing a second option for adjusting the relative position of the spring plate with respect to the sleeve;

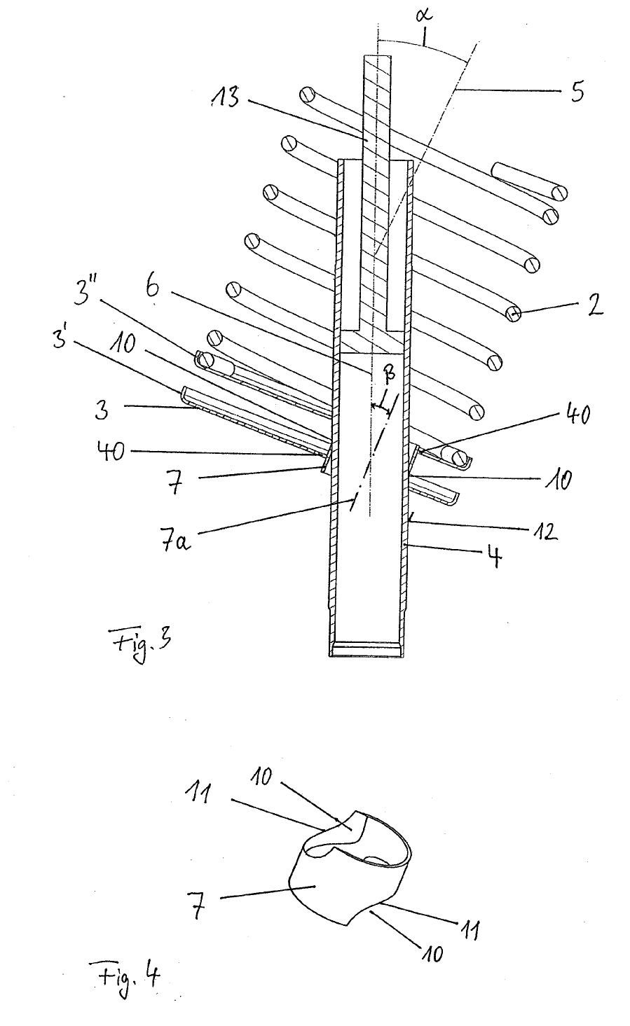

FIG. 3: illustrates an embodiment of the spring strut in accordance with the invention, different from FIG. 1 and 2;

FIG. 4: illustrates an isolated view of the sleeve for the embodiment in accordance with FIG. 3.

FIG. 1 shows a spring strut for motor vehicles having a vibration damper 1 and a helical spring 2 partially surrounding the vibration damper, wherein the helical spring is supported via a spring plate 3 on an outer pipe 4 of the vibration damper 1. The helical spring 2 has a line of application of force 5 which forms an acute angle α with the longitudinal axis 6 of the vibration damper 1.

The spring plate 3 is disposed so as to be displaceable with respect to the outer pipe 4. In the exemplified embodiment illustrated in FIG. 1 the adjustment of the spring plate 3 relative to the outer pipe 4 is effected by introducing spacing discs 9 between the spring plate 3 and the sleeve 7. The introduction of spacing discs 9, which are supported on a support collar 8 on the sleeve 7, causes the spring plate 3 to be displaced along the line of application of force 5 of the helical spring 2. In this way the length of the helical spring 2 is adjusted without the position of the line of application of force 5 of the spring 2 being changed with respect to the vibration damper 1. The transverse force transmitted from the helical spring 2 to the piston rod 13 of the vibration damper 1 remains the same for all spring lengths so that the friction between the piston rod 13 and the sealing and guiding assembly, not shown, also does not change, in particular it is not increased.

In order to connect the sleeve 7 firmly to the outer pipe 4 of the vibration damper 1 a fused connection in the form of a weld seam 20 is provided. Instead of a weld seam 20 a soldered connection or an adhesive connection could also be provided.

FIG. 2 shows another embodiment of the invention, wherein the same components are designated by the same reference numerals as in FIG. 1. In this embodiment of the invention the relative position of the spring plate 3 with respect to the sleeve 7 is fixed by the spring plate 3 being welded in the desired position to the outer surface of the sleeve 7 by a weld connection 30. After the spring plate 3 has been welded to the sleeve 7 the spring plate 3 can no longer be displaced. In this embodiment of the invention the vehicle spring is therefore brought to its length corresponding to the desired standing height of the vehicle by appropriate positioning of the spring plate 3 in the manufacturing plant, and the spring plate 3 is then fixed relative to the sleeve 7 by the weld 30. This embodiment also permits the sleeve 7 to be connected via an integrally bonded connection such as a weld connection 20 to the outer pipe 4 of the vibration damper.

FIG. 3 shows an embodiment of the invention different from FIG. 1 and 2. In this embodiment of the invention the sleeve 7 is also disposed in an inclined manner with respect to the outer pipe 4, wherein the outer pipe 4 partially penetrates the sleeve 7, which is disposed with its centre line 7a inclined with respect to the longitudinal axis 6 of the outer pipe 4, such that the sleeve 7 has apertures 10 which receive the outer pipe 4. The apertures 10 are defined by a penetration curve 11 (cf. FIG. 4) which is adapted to the surface 12 of the outer pipe. The sleeve 7 is connected at least in portions to the outer pipe 4 along the edge of the two apertures 10 by welded, soldered or adhesive connections, not shown. However it may also be sufficient to connect the sleeve 7 to the outer pipe 4 only along one of the edges of one of the apertures 10.

In the exemplified embodiment illustrated in FIG. 3 the centre line 7a of the sleeve 7 forms an acute angle β with the longitudinal axis 6 of the outer pipe 4 of the vibration damper 1. The outer surface of the sleeve 7 forms a guide surface for the displacement of the spring plate 3. In FIG. 3 two different positions for one and the same spring plate 3 are shown. In order for the spring plate 3 to be displaceable from a lower position 3′ relative to the sleeve 7 into an upper position 3″ the spring plate 3 has apertures 40 in the region in which the outer pipe 4 of the vibration damper 1 penetrates the sleeve 7. These apertures 40 permit displacement of the spring plate 3 along the whole outer surface of the sleeve 7. In the illustrated exemplified embodiment of FIG. 3 the centre line 7a of the sleeve 7 is approximately parallel to the line of application of force 5 of the helical spring 2, wherein, however, it is pointed out that this does not have to be the case.

The spring plate 3 is connected to the sleeve 7 by a welded connection which is not shown in FIG. 3 for the sake of clarity. Alternatively or additionally the spring plate 3 can also be attached to the sleeve 7 by soldered or adhesive connections. It is also possible to provide the sleeve 7 with an outer thread and the inner diameter of the spring plate 3 with an inner thread so that the position of the spring plate 3 on the sleeve 7 can be changed by a screwing rotation and the spring plate 3 can be fixed on the sleeve 7 e.g. by means of a counter nut as a way of securing against rotation.

For the sake of explanation FIG. 4 shows the sleeve 7 in accordance with the exemplified embodiment of FIG. 3 as an isolated component. The apertures 10 defined by the penetration curves 11 are clear to see. With its penetration curves 11 the sleeve 7 lies against the outer pipe 4 of the vibration damper during assembly so that the sleeve 7 is positioned at an angle with respect to the outer pipe 4 and the sleeve 7 can be fixed to the outer pipe 4 e.g. by a welded connection.

A common feature of all the embodiments of the present invention is that they can be used in a highly flexible manner in very different spring struts and therefore in very different installation situations. While in the case of the exemplified embodiments illustrated in FIGS. 1 and 2 the acute angle α between the line of application of force 5 of the helical spring 2 and the longitudinal axis 6 of the vibration damper 1 is about 11°, in the case of the exemplified embodiment illustrated in FIG. 3 this angle has a value of about 23°. The acute angle β (cf. FIG. 3) which is formed by the centre line 7a of the sleeve 7 and the longitudinal axis 6 of the outer pipe 4 can correspond to the acute angle α. In this case a displacement of the spring plate 3 does not effect any change on the transverse force acting on the piston rod and therefore any change in the friction. The person skilled in the art will therefore try to select the angle β in such a way that it corresponds to the angle α.

However, it is feasible that for constructional reasons in an actual situation where the spring strut is being installed in a vehicle chassis it may not be possible to select the angle β to be precisely the same size as the angle α. In this case the person skilled in the art will try to select the angle β in such a way that it comes as close as possible to the angle α. Owing to the fact that the two angles differ from each other in this case, in the event of a displacement of the spring plate 3 along the centre line 7a of the sleeve 7, a certain change in the transverse force acting on the piston rod is effected and must be taken into consideration. If this change in the transverse force does not exceed a limit of acceptability to be defined by the manufacturer no further steps need to be taken. However, if the influence of the transverse force exceeds a defined limit of acceptability the manufacturer can resort to additional measures to compensate for the undesired change in the transverse force. Such measures can consist e.g. of inclining the lower spring plate 3 and/or the upper spring plate relative to the line of application of force 5 of the helical spring 5 in such a way as to compensate for the change in the transverse force effected by the spring plate displacement. It is also important in this case when the angle β is not precisely the same size as the angle α that the teaching of the present invention is applied because there is also then a displacement of the spring plate 3 substantially in the direction of the line of application of force 5 of the helical spring 2. The term “substantially” expresses that the teaching of the present invention also includes cases in which the displacement of the spring plate 3 does not take place in a geometrically precise manner exclusively in the direction of the line of application of force 5 of the helical spring 2.

1. A spring strut for wheel suspension systems of vehicles, having a vibration damper and a helical spring partially surrounding the vibration damper wherein the helical spring is supported via a spring plate on an outer pipe of the vibration damper and the spring plate can be adjusted relative to the outer pipe characterized in that the line of application of force of the helical spring forms an acute angle with the longitudinal axis of the vibration damper and the position of the spring plate can be adjusted substantially in the direction of the line of application of force.

2. The spring strut as claimed in claim 1, wherein a hollow-cylindrical sleeve is disposed on the outer pipe of the vibration damper on which sleeve the spring plate is supported.

3. The spring strut as claimed in claim 2, wherein the centre line of the sleeve forms an acute angle with the longitudinal axis of the outer pipe.

4. The spring strut as claimed in claim 1, wherein the spring plate is displaceably disposed substantially in the direction of the line of application of force.

5. The spring strut as claimed in claim 4, wherein the outer surface of the sleeve forms a guide surface for the displacement of the spring plate.

6. The spring strut as claimed in claim 2, wherein the sleeve has a support collar on which spacing discs are supported, and that by means of the spacing discs the relative position of the spring plate to the sleeve can be adjusted.

7. The spring strut as claimed in claim 3, wherein the outer pipe partially penetrates the sleeve which is disposed with its centre line inclined with respect to the longitudinal axis of the outer pipes such that the sleeve has apertures which receive the outer pipe.

8. The spring strut as claimed in claim 7, wherein the apertures are defined by a penetration curve which is adapted to the surface of the outer pipe.

9. The spring strut as claimed in claim 7, wherein the sleeve is connected at least in portions to the outer pipe along the edge of at least one of the apertures.

10. The spring strut as claimed in claim 9, wherein the connection is a welded, soldered or adhesive connection or a plug or clamped connection.
